(19) United States
(12) Patent Application Publication
(10) Pub. No.: US 2025/0292686 A1
(43) Pub. Date: Sep. 18, 2025

(54) VEHICLE SAFETY SYSTEM WITH 360-DEGREE VIEW, BLIND SPOT MITIGATION, AND DRIVE ASSIST FEATURES

(71) Applicant: ADEL ALBAZEI, Riyadh (SA)

(72) Inventor: ADEL ALBAZEI, Riyadh (SA)

(21) Appl. No.: 18/606,565

(22) Filed: Mar. 15, 2024

(51) Int. Cl. G08G 1/16; B60W 30/16; B60W 50/14; G08G 1/01

(52) U.S. Cl. CPC G08G 1/167; B60W 30/162; B60W 50/14; G08G 1/0125; B60W 2050/146; B60W 2420/403; B60W 2420/408; B60W 2554/801; B60W 2556/45; B60W 2754/30

(57) ABSTRACT

A comprehensive solution designed to enhance driver awareness, mitigate blind spots, provide a 360-degree view, and offer drive assist features and its characterized by a plurality of ultra-night vision multi micro CCD cameras, each equipped with an image sensor for capturing high-resolution images in low-light conditions, high-definition low-distortion lenses individually associated with each camera, ensuring accurate and distortion-free representation of the surroundings, and a LCD screen integrated into the vehicle's dashboard or rearview mirror. A dedicated video processor configured for continuous trip recording. a controller analyzing processed camera feeds to generate size and position signals for vehicles approaching from any side, advanced image recognition algorithms employed by the controller for precise size and position signal generation, drive assist radar sensors employing radar technology to detect and track vehicles in front of the user's vehicle and, advanced algorithms connected with the SOS system inside the car.

### FIELD OF THE INVENTION

The present invention pertains to the field of automotive safety systems, particularly a comprehensive solution designed to enhance driver awareness, mitigate blind spots, provide a 360-degree view, and offer drive assist features.

### BACKGROUND OF THE INVENTION

Conventional vehicular safety systems often face challenges in providing a complete and real-time view of the vehicle's surroundings, especially in low-light conditions and blind spots. Accidents resulting from poor visibility and inadequate warning systems necessitate a more advanced and integrated solution.

Vehicular safety systems have undergone a transformative evolution, driven by advancements in sensor technologies, artificial intelligence, and a growing emphasis on enhancing overall road safety. Modern vehicles are equipped with a plethora of features that extend beyond traditional safety measures, offering comprehensive solutions to address challenges such as blind spots, limited visibility, and collision avoidance.

In U.S. Pat. No. 11,308,641 an oncoming car detection system using lateral emirror cameras is described. An apparatus including an interface and a processor are also described. The interface may be configured to receive first video frames of a first field of view captured by a first capture device and second video frames of a second field of view captured by a second capture device. The first capture device and the second capture device may have a symmetrical orientation with respect to a vehicle. The fields of view may have an overlapping region. The processor may be configured to select the capture devices to operate as a stereo pair of cameras based on the symmetrical orientation, receive the video frames from the interface, detect an object located in the overlapping region, perform a comparison operation on the object based on the symmetrical orientation with respect to the video frames and determine a distance of the object from the vehicle in response to the comparison operation.

While the described invention presents several advantages, it is essential to consider potential disadvantages or limitations:

Limited Field of View: The invention relies on a symmetrical orientation of two capture devices, resulting in a potentially limited field of view. This limitation may affect the system's ability to detect objects outside the overlapping region behind the vehicle.

Dependency on Symmetry: The effectiveness of the stereo pair operation is contingent upon the symmetrical orientation of the first and second capture devices. As a result, if the vehicle undergoes modifications or has an asymmetrical design, the system may not perform optimally.

Sensitivity to Calibration: The proper calibration of the capture devices is crucial for accurate distance determination. Any misalignment or calibration issues between the devices may lead to inaccuracies in object distance calculations.

Object Detection Limited to Overlapping Region: The invention focuses on detecting objects within the overlapping region behind the vehicle. This limitation may result in reduced effectiveness in scenarios where objects are located outside this specific area.

Dependency on Video Frame Quality: The accuracy of distance determination and object detection is reliant on the quality of the video frames captured by the first and second capture devices. Adverse weather conditions, poor lighting, or camera malfunctions may impact the system's performance.

Lack of Night Vision Capability: The description does not explicitly mention night vision capabilities. In scenarios with low-light conditions, the system may struggle to detect objects effectively, potentially compromising safety during nighttime driving.

Limited Adaptability to Varied Environments: The invention's reliance on a specific symmetrical orientation and overlapping region may limit its adaptability to different vehicle designs and diverse driving environments.

Complexity of Comparison Operation: Performing a comparison operation on objects based on symmetrical orientation may introduce computational complexity. This could lead to potential delays in determining object distance and responsiveness in real-time driving scenarios.

Dependency on Stereo Pair Operation: The stereo pair operation is a critical aspect of the invention. If one of the capture devices malfunctions or fails, the system's ability to accurately determine distances and detect objects may be compromised.

Potential Interference Issues: If there are multiple vehicles equipped with similar systems in close proximity, there may be interference or crosstalk issues between their stereo pairs, affecting the accuracy of distance calculations and object detection.

### SUMMARY OF THE INVENTION

The described invention marks a notable advancement in vehicular safety technology, offering a nuanced approach to address challenges associated with blind spots and limited visibility. At its core, the system incorporates an interface and a processor, orchestrating the seamless integration of two capture devices—each capturing a distinct field of view behind the vehicle. The uniqueness lies in the symmetrical orientation of these devices, strategically positioned to maximize their effectiveness in creating a stereo pair of cameras.

The symmetrical orientation principle is designed to enhance object detection, particularly in the overlapping region behind the vehicle. By selecting the first and second capture devices to operate as a stereo pair, the system aims to leverage the symmetrical alignment for accurate distance determination of detected objects. This approach utilizes advanced image processing algorithms, performed by the processor, to conduct a meticulous comparison operation on the video frames obtained from both cameras.

The invention's functionality is not only limited to real-time object detection but extends to the crucial task of calculating the precise distance of detected objects from the vehicle. This detailed distance determination is pivotal for providing drivers with accurate information about their surroundings, contributing significantly to overall road safety. Additionally, the system's reliance on stereo imaging and symmetrical orientation aligns with a trend in cutting-edge safety systems, where three-dimensional perception and advanced sensor technologies play an increasingly vital role.

While the invention introduces innovative concepts to improve object detection and distance calculation, potential challenges may arise, including the system's sensitivity to calibration accuracy, limited adaptability to asymmetrical vehicle designs, and dependency on optimal weather and lighting conditions for accurate image processing. Nevertheless, the detailed and precise nature of the invention positions it as a promising addition to the evolving landscape of vehicular safety technologies, contributing to the ongoing pursuit of intelligent, adaptive, and reliable safety solutions for modern vehicles.

Also the presented integration system will include a front and rear radar sensor which will help the driver be more aware of the speed of the vehicles around and alert the driver if there is any approaching vehicle coming around with high risk such as speeding.

The presented integration system doesn't only provide an enhancement for the safety of the drivers, but also will help insurance companies and police officers detect the accidents more precisely which will help the insurance companies save a lot of money and the police officers to solve a lot of unsolved crimes.

### BRIEF DESCRIPTION OF THE DRAWINGS

FIG. 1 illustrates a general depiction of the integration system describing the side cameras angle according to the present invention.

FIG. 2 illustrates a general depiction of the integration system describing how the cameras record and spot all the blind spots around the vehicle according to the present invention.

FIG. 3 illustrates a general depiction of the integration system describing how the spotted body will be detected on the LCD screen according to the present invention.

### DETAILED DESCRIPTION OF THE INVENTION

The present invention relates to a comprehensive vehicular safety system designed to overcome blind spots, provide a 360-degree view, enhance object approaching visibility, and facilitate drive assistance. The system integrates ultra-night vision multi micro CCD cameras, high-definition low-distortion lenses, a front dashboard LCD screen, a video processor for trip recording, warning systems for approaching vehicles, drive assist radar sensors and a G-Force sensor. The combination of these components enables a sophisticated safety solution that not only improves driver awareness but also aids in accident detection and reconstruction.

Also the integration system is connected to our other patent application number WO2023128840 and titled “Unique Code.” All the cars using the integration system is connected to the owner unique code in which when the law enforcement would like to access the footage they can access it using the owner's unique code.

### Ultra-Night Vision Multi Micro CCD Cameras:

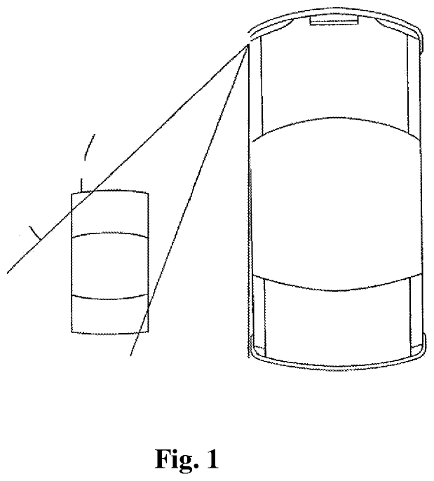

The system incorporates a set of ultra-night vision multi micro CCD cameras placed strategically around the vehicle as shown in FIG. 1. The system will include 8 cameras (e.g., on four sides, front side, rear side, under the vehicle and above the vehicle). These cameras utilize advanced imaging technology to capture high-resolution images in low-light conditions, ensuring optimal visibility during nighttime driving.

### High Definition Low Distortion Lens:

Each camera is equipped with a high-definition low-distortion lens, minimizing optical aberrations and ensuring that the captured images accurately represent the surroundings. This feature contributes to the system's ability to provide a distortion-free, clear, and detailed 360-degree view.

### LCD Panels:

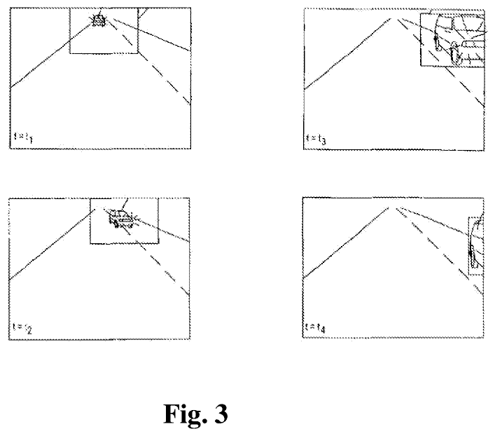

As shown in FIG. 3, the LCD panels are seamlessly integrated into the vehicle's dashboard or rearview mirror. These panels display real-time feeds from the cameras, offering the driver an easily accessible and consolidated visual representation of the vehicle's surroundings. The display aids in monitoring blind spots and approaching vehicles.

### Video Processor for Trip Recording:

A dedicated video processor continuously records the trip by capturing and storing footage from the cameras. This recorded data serves as a valuable tool for accident reconstruction, providing a detailed account of events leading up to an accident. Insurance companies and law enforcement can utilize this information to determine liability. But the insurance companies only can access the saved footage with an approval from the law enforcement. Also to be able to access the system the law enforcement can access all of the footage using the unique code of the owner of the car to make sure that the privacy of driver is protected.

### Warning System for Approaching Vehicles:

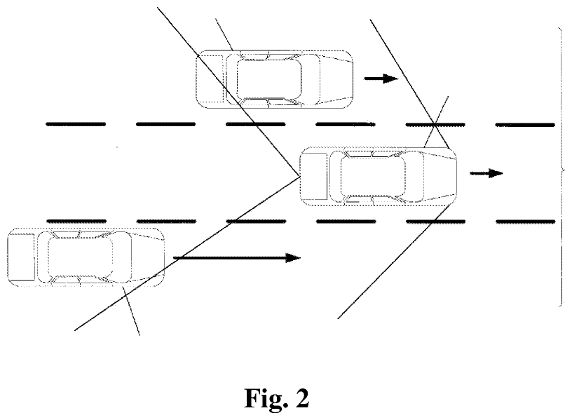

As shown in FIG. 2, the system includes a warning system that utilizes the processed camera feeds. A controller analyzes the images, generating size and position signals for vehicles approaching from any side. When a rear-approaching vehicle enters a blind spot, the controller activates an indicator to alert the driver, enhancing situational awareness and preventing potential collisions. And also the system is connected to the police stations and hospital in case of any major accident happens the system will transmit a signal to the nearest police station and hospital using the SOS system inside the car. Also in order to be sure that the system only calls the police station and hospitals on major accident, the system will include a G-force sensor calculator to calculate the G-force of the accident and with respect to the calculation the system will analyze wither it's a major accident and the driver or the passengers need an immediate help or it's a minor accident and no one inside the vehicles got hurted.

### Drive Assist Radar Sensors:

Complementing the visual components, the system incorporates drive assist radar sensors to detect vehicles in front of the user's vehicle. These sensors provide early warnings, contributing to collision avoidance and facilitating adaptive cruise control features for a safer driving experience.

### G-Force Sensor:

The enhanced vehicular safety system, now equipped with a G-Force sensor for precise accident severity analysis, includes an innovative feature that seamlessly connects the system with emergency services. In the event that the G-Force sensor determines a major accident, the system triggers an automatic connection with the SOS system inside the vehicle. This connection enables the system to promptly contact the nearest police station and/or hospital, providing vital information about the accident's severity and location. This rapid and automated response not only expedites emergency services but also ensures that critical accident details are communicated promptly, improving overall response times and potentially minimizing the impact of injuries and damages.

### Advantages:

The invention offers several advantages, including improved nighttime visibility, comprehensive 360-degree monitoring, effective blind spot mitigation, and advanced drive assist features. The integration of these components results in a holistic approach to vehicular safety, reducing the likelihood of accidents and enhancing overall road safety.

The described vehicular safety system, based on symmetrical orientation and stereo imaging, offers a multifaceted approach to overcome challenges associated with blind spots and limited visibility. The unique advantage of creating a stereo pair of cameras with strategically positioned capture devices lies in its ability to significantly reduce false alarms. By precisely selecting the first and second capture devices to operate in tandem based on their symmetrical alignment, the system enhances object detection accuracy, ensuring that warnings are triggered only in the presence of genuine threats within the overlapping region behind the vehicle.

An added benefit of the invention is the improved depth perception it provides to drivers. The stereo imaging approach not only facilitates meticulous object detection but also contributes to a more comprehensive understanding of object distances from the vehicle. This enhanced depth perception is invaluable in scenarios where precise distance calculations are crucial for informed decision-making. Furthermore, the system's potential for dynamic calibration adjustment makes it adaptable to changes in the vehicle's configuration, offering a level of flexibility that ensures optimal performance even as the vehicle undergoes modifications.

The advantages extend beyond accurate object detection and distance determination to include improved object tracking within the overlapping region. The stereo pair of cameras enables effective tracking of moving objects, enhancing overall situational awareness. The invention's potential to integrate with driver assistance features, provide real-time feedback and alerts, and contribute to the safety of autonomous driving systems positions it as a comprehensive solution in the ever-evolving landscape of vehicular safety technologies. The scalability across vehicle types and potential for weather-resistant operation further highlight the invention's versatility and applicability in diverse driving conditions.

In addition to the previously outlined advantages, the invention incorporates several noteworthy features that further elevate its efficacy in enhancing vehicular safety. One notable enhancement is the inclusion of a G-force sensor, a critical component that calculates the power of an accident. This sensor serves as a pivotal addition to the system's capabilities, providing valuable data for post-accident analysis and contributing to the evolution of accident reconstruction technologies. The G-force sensor measures the gravitational force experienced during a collision, offering insights into the severity of the impact. This data is instrumental for accurately assessing the potential damage, understanding the dynamics of the collision, and providing detailed information for insurance claims and law enforcement investigations.

In conclusion, the disclosed comprehensive vehicular safety system represents a significant advancement in automotive safety technology, providing a solution that addresses the limitations of existing systems and contributes to safer and more secure driving experiences.

What is claimed is:

1. A vehicle safety system with 360-degree view, blind spot mitigation, and drive assist features, comprising:
a plurality of ultra-night vision multi micro CCD cameras, each equipped with an image sensor for capturing high-resolution images in low-light conditions;
high-definition low-distortion lenses individually associated with each camera, ensuring accurate and distortion-free representation of the surroundings;
a LCD screen integrated into the vehicle's dashboard or rearview mirror;
a dedicated video processor configured for continuous trip recording;
a controller analyzing processed camera feeds to generate size and position signals for vehicles approaching from any side;
advanced image recognition algorithms employed by the controller for precise size and position signal generation;
drive assist radar sensors employing radar technology to detect and track vehicles in front of the user's vehicle; and
advanced algorithms connected with an SOS system inside the car.

2. The invention according to claim 1, wherein the LCD screen displays real-time feeds from the plurality of cameras, providing a consolidated and easily accessible 360-degree view to the driver.

3. The invention according to claim 1, wherein the video processor captures and stores synchronized footage from the plurality of cameras with timestamps and geospatial data.

4. The invention according to claim 1, further comprising an indicator, communicatively coupled to the controller, that is activated when a rear-approaching vehicle enters a predefined blind spot based on the generated signals.

5. The invention according to claim 1, wherein early warning capabilities provided by the drive assist radar sensors offer real-time alerts to the driver, and detect vehicles in front of the user's vehicle using drive assist radar sensors equipped with radar technology for accurate distance measurement and tracking.

6. The invention according to claim 1, further comprising processing camera feeds to generate size and position signals for vehicles approaching from any side, utilizing advanced image recognition algorithms.

7. The invention according to claim 1, further comprising an indicator, wherein the indicator is activated when a rear-approaching vehicle enters a predefined blind spot based on the generated size and position signals.

8. The invention according to claim 1, further comprising adaptive cruise control features to dynamically adjust the vehicle's speed for maintaining a safe following distance based on information from the drive assist radar sensors and adaptive cruise control features utilizing information from the drive assist radar sensors to dynamically adjust the vehicle's speed for maintaining a safe following distance,

9. The invention according to claim 1, wherein recorded footage and sensor data is transmitted to external devices for accident reconstruction, insurance purposes, law enforcement analysis and transmit a signal to the nearest police station and hospital using the SOS system inside the cars.
